(19) United States
(12) Patent Application Publication
(10) Pub. No.: US 2022/0309959 A1
(43) Pub. Date: Sep. 29, 2022

(54) DUAL-COLOR REUSABLE BOTTLE LABEL

(71) Applicant: InchBug, LLC, Austin, TX (US)

(72) Inventors: Brenda Lee Feldman, Austin, TX (US); Roy Paul Prosise, Cedar Park, TX (US); Logan Paul Prosise, Cedar Park, TX (US); Cohl Thomas Prosise, Cedar Park, TX (US)

(21) Appl. No.: 17/301,119

(22) Filed: Mar. 25, 2021

(51) Int. Cl. G09F 3/02; G09B 21/00; B65D 23/08

(52) U.S. Cl. CPC G09F 3/02; G09B 21/003; B65D 23/0842; G09F 2003/0208; G09F 2003/0251; G09F 2003/0257; G09F 2003/0273

(57) ABSTRACT

Embodiments, apparatuses, and systems associated with providing a two color etchable label for a drinking vessel. In some cases, the label may be formed from two or more layers, each layer having a different color. In some cases, the length of the label may have a first portion and a second portion. The thickness of the label may comprise substantially equal portions of the first layer and the second layer at the first portion and the thickness of the label may be predominately formed from one of the layers at the second portion.

### BACKGROUND

Bottle labels are typically in the form of a single use stick on or adhesive strip. The adhesive strip may be pealed and placed on a bottle. In some cases, the adhesive strip may be formed from paper or line products and may be dishwasher safe. However, once the adhesive strip is applied, the strip cannot be easily removed or transferred to a new bottle, thereby preventing the bottle from being used for a second or third child.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial view of an example label in accordance with embodiments of the disclosure.

FIG. 2 is another pictorial view of the example label of FIG. 1 in accordance with embodiments of the disclosure.

FIG. 3 is another pictorial view of the example label of FIG. 1 in accordance with embodiments of the disclosure.

FIG. 4 is another pictorial view of the example label of FIG. 1 in accordance with embodiments of the disclosure.

FIG. 5 is a cross-sectional view of the example label of FIG. 1 in accordance with embodiments of the disclosure.

FIG. 6 is a top-down view of the example label of FIG. 1 in accordance with embodiments of the disclosure.

FIG. 7 is another top-down view of the example label of FIG. 1 in accordance with embodiments of the disclosure.

FIG. 8 is another cross-sectional view of the example label of FIG. 1 in accordance with embodiments of the disclosure.

FIG. 9 is a flow diagram illustrating an example process associated with the label of FIG. 1 in accordance with embodiments of the disclosure.

### DETAILED DESCRIPTION

Discussed herein are embodiments, apparatuses, and systems for providing a reusable label for a bottle or other drinking vessel. In some implementations, the system may include a ring-shaped label that is configured to fit or mate around the exterior of a bottle or other drinking vessel. In some cases, the label be formed from multiple layers of material. Each layer may be formed from at least one of silicone, and the like. In some cases, each layer of the label may have a different color, such that a first external layer differs in color from a second interior layer. In one example, a name of an individual associated with the label may be laser etched into the label by removing a portion of the exterior layer associated with the name of the individual.

In some cases, the layers of the label may not be uniform throughout the ring. For example, on a first portion of the ring the outer layer may be approximately fifty percent of the thickness and a second layer (e.g., the inner layer) of the ring may be approximately fifty percent of the thickness. At a second portion of the ring, the outer layer may be less than two percent of the thickness of the ring while the second layer may be greater than ninety-eight percent of the thickness of the ring. In another example, at the first portion of the ring the outer layer may be approximately fifty percent of the thickness and a second layer (e.g., the inner layer) of the ring may be approximately fifty percent of the thickness. In this example, at the second portion of the ring, the outer layer may be less than one and half percent of the thickness of the ring while the second layer may be greater than ninety-eight percent of the thickness of the ring. For instance, in one specific example, at the first portion the outer layer may be approximately 0.0375 of an inch thick and the second layer may also be approximately 0.0375 of an inch thick. In this specific example, at the second portion the outer layer may be approximately 0.01 of an inch thick and the second layer may be approximately 0.075 of an inch thick.

In some implementations, the thickness of the ring of the label at the second portion may be greater than the thickness of the ring at the first portion. For instance, in one specific example, the thickness of the ring at the first portion may be approximately 0.075 of an inch and the thickness may be approximately 0.085 of an inch at the second portion of the ring. In some cases, the first portion of the ring may comprise three-fourth of the length of the ring and the second portion may comprise one-fourth of the length of the ring. In another example, the first portion of the ring may comprise two-thirds of the length of the ring and the second portion may comprise one-third of the length of the ring. In other examples, the second portion may comprise half of the length of the ring, one-tenth the length of the ring, one-twenty of the length of the ring, and the like. In some cases, by minimizing the length of the second portion of the ring, scratches and other damage to the label may be less noticeable.

In the examples, the name of the individual may be laser etched into the second portion of the ring, such that the resulting label has an exterior color of the ring and an interior color is exposed at the location or over the letters of the name of the individual. Thus, unlike conventional labels that include only a single color, the labels, discussed herein, may be easily read and the owner identified.

In some cases, the label may also include a brail version of the name along the first portion of the ring. In these cases, the brail may extend outward from the exterior surface of the first portion of the ring. In some instance, the brail may also correspond to the name of the user and formed via molding. Thus, in some cases, the label may include both a custom mold phase to customize the label to include the brail version of the individual's name on the first portion of the label and a laser etching phase in which the individuals name is etched into the second portion of the label.

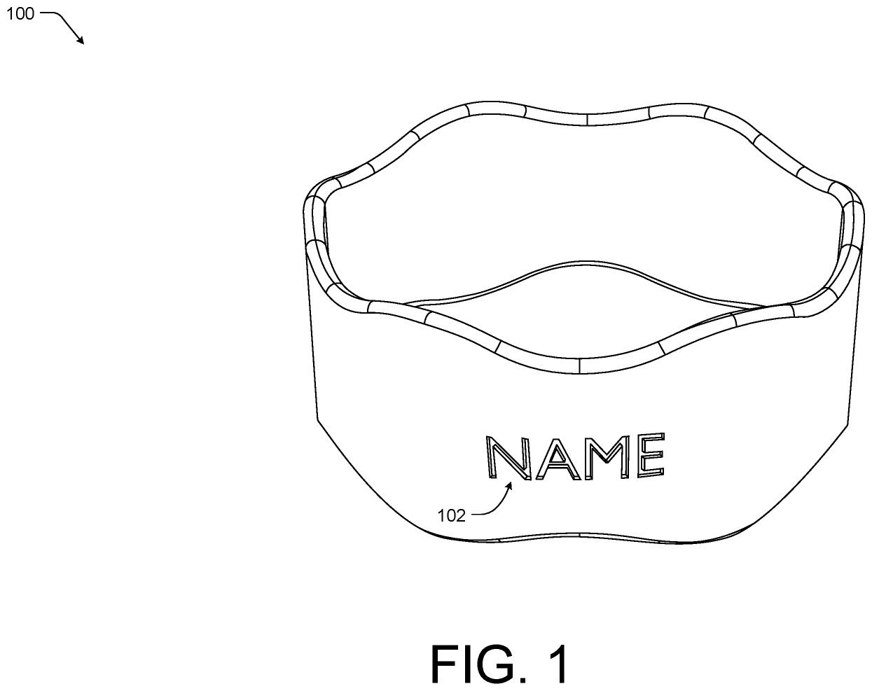

FIG. 1 is a pictorial view of an example label 100 accordance with embodiments of the disclosure. As shown in the illustrated example, the label 100 may be substantially ring shaped to fit or otherwise mate with a bottle or other drinking vessel. In the current example, the label 100 has not been personalized to include a name, address, and/or other personal identifiable information 102 for a specific individual. The label 100 may be formed from two or more layers of silicone, other elastomers, or other polymers. Each of the layers may be have a different color to assist with visibility when the label is etched with the personal identifiable information 102.

In some cases, the label 100 may be between approximately 1 and 4 inches in height. In the illustrated example, the label 100 may include a variable height at which the height varies between a first minimum value and a second maximum value. However, in other examples, the height of the label 100 may be uniform for the enter circumference. The label 100 may also have a radius of between approximately 3 and 8 inches. In some implementations, the width or thickness of the label 100 may vary from a first portion to a second portion, as discussed above. For example, the thickness of the label 100 may be between approximately 0.1 and 0.3 inches at a first portion of the label and at a second portion of the label 100. In these implementations, the first potion may include substantially equal layers while the second portion may include one thick layer and one thin layer, such that the thin layer may be laser etched with the personal identifiable information 102 to reveal the color of the thick layer. In this manner, the majority of the label 100 may be a first color and the personal identifiable information 102 may be in a second color. In some cases, the percentage or amount of the label 100 formed by the second portion may be less than half of the length of the label 100, less than one third the length of the label 100, less than one fourth the length of the label 100, less than one tenth the length of the label, or the like.

In one specific example, the size or percentage of the first and second portions may be based on a length or number of characters associated with the personal identifiable information 102. For example, the percentage of the label 100 associated with the second portion (e.g., the portion having a thick layer and a thin layer) may be a threshold distance greater than the area to be etched or the number of characters in the individuals name.

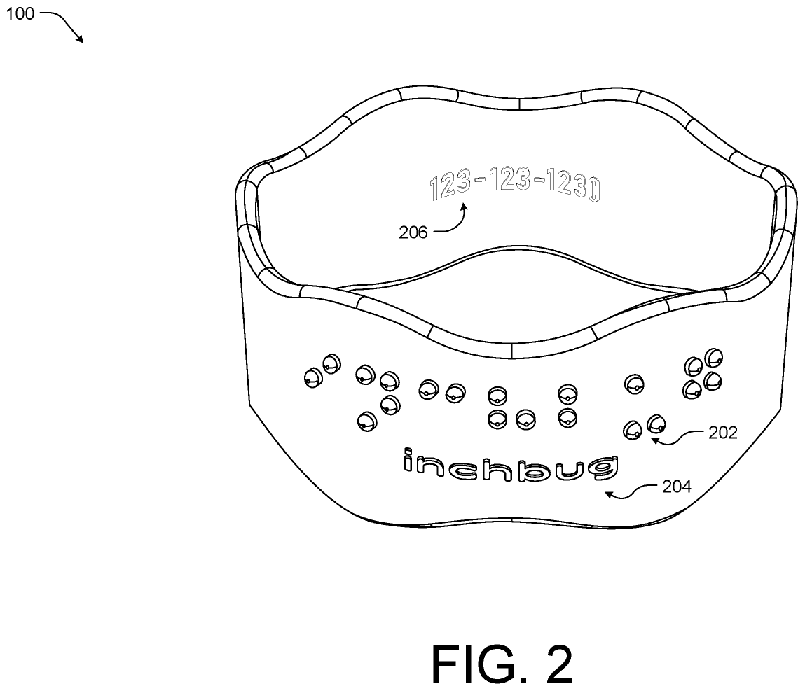

FIG. 2 is a pictorial view of the example label 100 of FIG. 1 accordance with embodiments of the disclosure. In the current example, an reverse or opposite side of the label 100 is shown. For example, in FIG. 1, the side of the label 100 associated with the second portion (e.g., the portion with unequal layers) of the label 100 is visible, while, in FIG. 2, the side of the label 100 associated with the first portion (e.g., the substantially equal layers) is shown. In the current example, in addition to the etched personal identifiable information 102 of FIG. 1, the label 100 may also include a molded or otherwise raised portion 202. For example, the label 100 may include a brail version 202 of the personal identifiable information 102 that was etched on the second portion. The brail version 202 may be associated or arranged along the first portion of the label 100 and added during the molding process, such that the brail version 202 is raised, such that individuals may feel or read the raised portion using touch.

The label 100 may also include a second raised portion 204. In the current example, the second raised portion includes additional informatic associated with the individual owner of the label 100. However in other cases, the second raised portion 204 may be molded version of the personal identifiable information 102 and/or additional information associated with the label 100 itself. In still other examples, the second raised portion 204 may include information such as phone numbers, addresses, parental names or data, emergency contact information, and the like. The current example also illustrates a third raised portion 206 along the interior of the label 100. The third raised portion 206 may also include additional informatic associated with the individual owner of the label 100, additional information associated with the label 100 itself, as well as other information, such as phone numbers, addresses, parental names or data, emergency contact information, and the like.

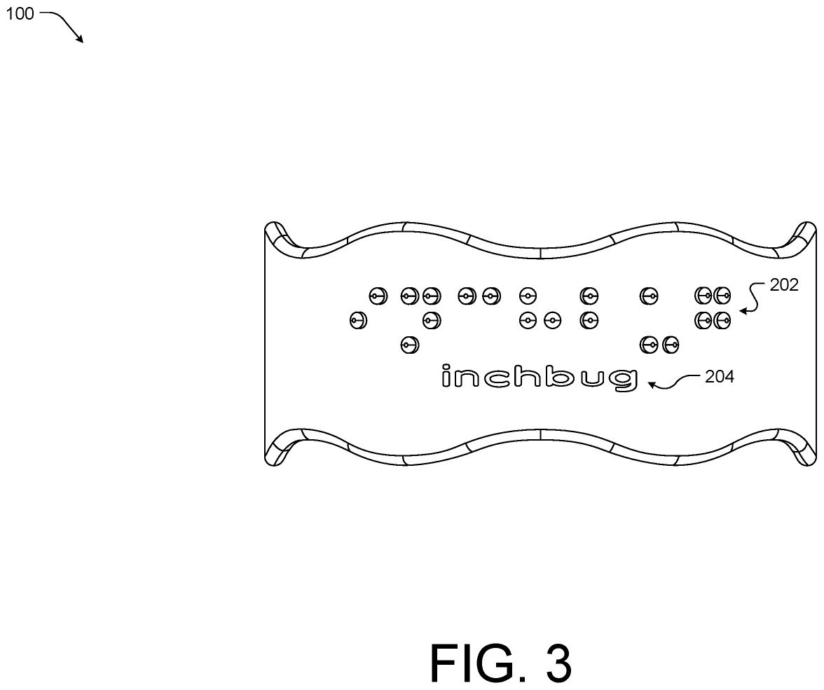

FIG. 3 is another pictorial view of the example label 100 of FIG. 1 accordance with embodiments of the disclosure. In the current example, the first portion (e.g., the substantially equal layers) of the label 100 is shown. Currently, the first raised portion 202 and the second raised portion 204 of the label 100 are visible. Again, the first raised portion 202 may include a brail version of the personal identifiable information 102 that is laser etched along the opposite or reverse side of label 100.

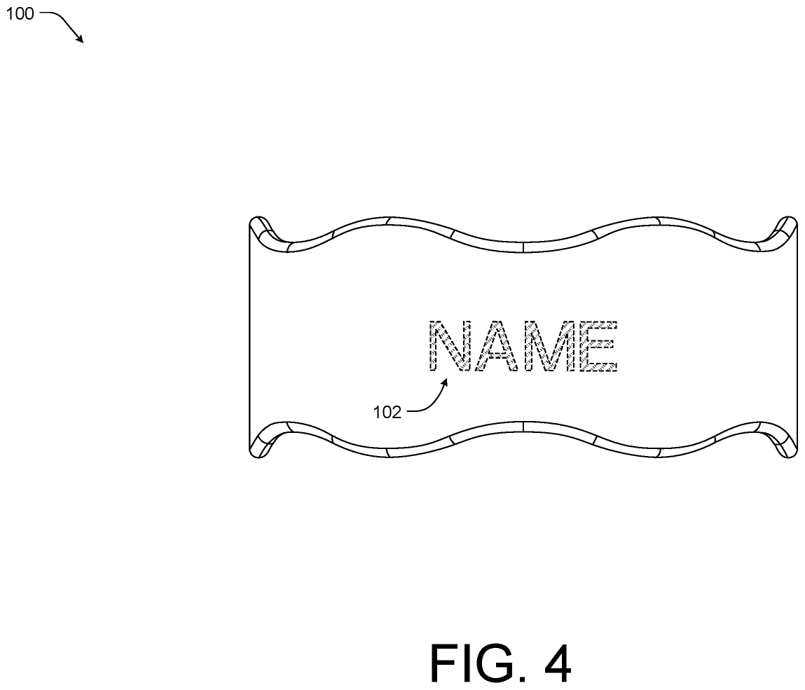

FIG. 4 is another pictorial view of the example label of FIG. 1 accordance with embodiments of the disclosure. In the current example, the second portion (e.g., the substantially unequal layers) of the label 100 is shown. As illustrated, the label 100 has been laser etched along the second portion to expose the second layer (e.g., the interior layer) of material. Thus, the color of the second layer is visible along the outline of the personal identification information 102 (e.g., in the illustrated example, the name of the individual associated with the label 100).

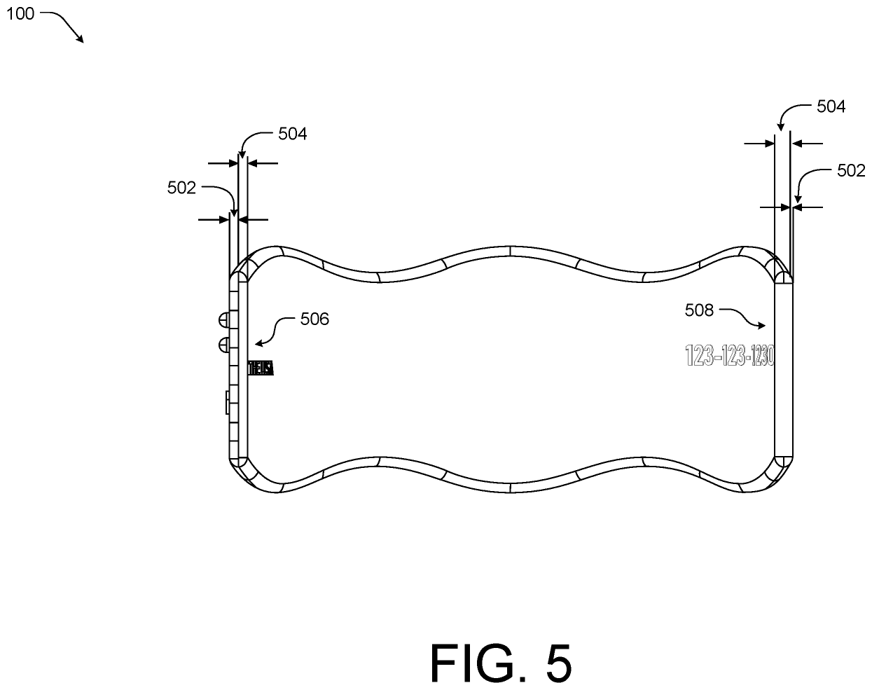

FIG. 5 is a cross-sectional view of the example label 100 of FIG. 1 accordance with embodiments of the disclosure. In the current example, the label 100 is formed from a first layer 502 and a second layer 504. The first layer 402 may form the exterior of the label 100 and the second layer 504 may form the interior of the label 100. As discussed above, the first layer 502 and the second layer 504 may be formed from a silicone material, a polymer material, and/or an elastomer material. In some cases, the first layer 502 and the second layer 504 may be formed from the same material, while in other cases, the first layer 502 and the second layer 504 may be formed from different materials. Regardless as to the material, the first layer 502 and the second layer 504 may be formed from a different color.

As shown in the illustrated example, the first layer 502 and second layer 504 are not be uniform throughout the label 100. For example, the label 100 may have a first portion, generally indicated by 506, and a second portion, generally indicated by 408. At the first portion 506 the first layer 502 and the second layer 404 may be substantially equal. For instance, the first layer may comprise approximately one half of the thickness of the label 100 and the second layer may comprise approximately one half of the thickness of the label 100. In other examples, at the first portion 506 (e.g., the portion of the label 100 with the model personal identification information) the first layer 502 and/or the second layer 504 may be between approximate forty percent of the thickness of the label 100 and sixty percent of the thickness of the label 100.

At the second portion 508 (e.g., the portion of the label 100 with the etched personal identification information) of the label 100, the thickness of the first layer (e.g., the outer layer) may be relatively small or thin in comparison to the second layer 504 (e.g., the inner layer). For example, the first layer 502 may be less than two percent of the thickness of the label 100 while the second layer 504 may be greater than ninety-eight percent of the thickness of the label 100. In other examples, at the second portion 508, the first layer 502 may be between approximate eighty-five percent of the thickness of the label 100 and ninety-nine percent of the thickness of the label 100, while the second layer 504 may be between approximate fifteen percent of the thickness of the label 100 and one percent of the thickness of the label 100. In some specific examples, the thickness of the first layer 502 may be between approximate ninety-five percent of the thickness of the label 100 and ninety-nine percent of the thickness of the label 100 and the thickness of the second layer 504 may be between approximate five percent of the thickness of the label 100 and one percent of the thickness of the label 100. In some examples, the thickness of the first layer 502 and the second layer 504 at the second portion 508 may be based on a ratio. For example, at the second portion 508, the thickness of the first layer 502 to the thickness of the second layer 504 may be between 1 to 80 and 1 to 70. Likewise, at the first portion 506, the relative thicknesses may be defined by a ration. For example, at the first portion 506, the thickness of the first layer 502 to the thickness of the second layer 504 may be between 1 to 1 and 1 to 1.25.

In one specific example, the total thickness of the label 100 may vary between 0.75 of an inch thick and 0.76 of an inch thick. At the first portion 506, the first layer 502 may be approximately 0.0375 of an inch thick and the second layer 504 may also be approximately 0.0375 of an inch thick. In this specific example, at the second portion 408, the first layer 402 (e.g., the outer layer) may be approximately 0.01 of an inch thick and the second layer 404 (e.g., the inner layer) may be approximately 0.075 of an inch thick. As such, in this example, the thickness of the label 100 may be greater at sections corresponding to the second portion 508 than at sections corresponding to the first portion 506. In other instances, the thickness of the label 100 at the first portion 506 may be between approximately 0.070 and 0.080 of an inch and the thickness of the label 100 at the second portion 508 may be between approximately 0.075 and 0.086 of an inch.

In some implementations, the second portion 508 of the label 100 may comprise less than half of the length of the label 100, while the first portion 506 may comprise greater than half of the length of the label 100. In some cases, the length or size of the second portion 508 may be minimized to reduce changes of the first layer 502 being damaged during use, thereby exposing the second layer 504. For instance, the first portion 506 of the label 100 may comprise three-fourth of the length of the label 100 and the second portion 508 may comprise one-fourth of the length of the label 100. In another example, the first portion 506 may comprise two-thirds of the length of the label 100 and the second portion 508 may comprise one-third of the length of the label 100. In yet other examples, the second portion 508 may comprise half of the length of the label 100, one-tenth the length of the label 100, one-twenty of the length of the label 100, and the like. In some cases, the amount of the label 100 defined by either the first portion 506 or the second portion 508 may be based on a ratio. For example, the amount of the label associated with the first portion 506 in comparison to the second portion 508 may be 3 to 1, 3 to 2, 2 to 1, 9 to 1, 8.5 to 1.5, and the like.

In the illustrated example, a first layer 502 and a second layer 504 are shown. However, it should be understood that the label 100 may include additional layers, such that the label 100 includes two or more layers.

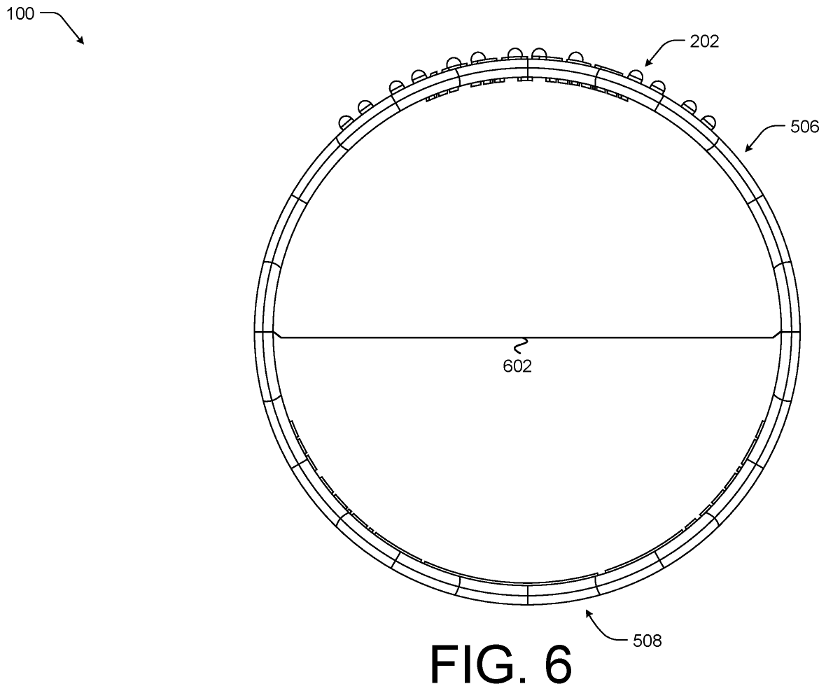

FIG. 6 is a top-down view of the example label 100 of FIG. 1 accordance with embodiments of the disclosure. As discussed above, the label 100 may have a first portion 506 that includes the molded or raised personal identification information 202 as well as a second raised portion 204 that may include additional information. The label 100 also includes a second portion 508 that has the substantially unequal layers configured to allow for laser etching of the personal identification information along the surface of the label 100. As discussed above, the amount, length, or size of the first portion 506 and the second portion 508 may differ. For example, the second portion 508 may comprise less than half of the length of the label 100 and the first portion 506 may comprise greater than half of the length of the label 100. In the current example, the label 100 also had a first or outer layer 502. In some cases, the diameter of the first layer 502 may vary based on the type of vessel that the label 100 is intended to mate with.

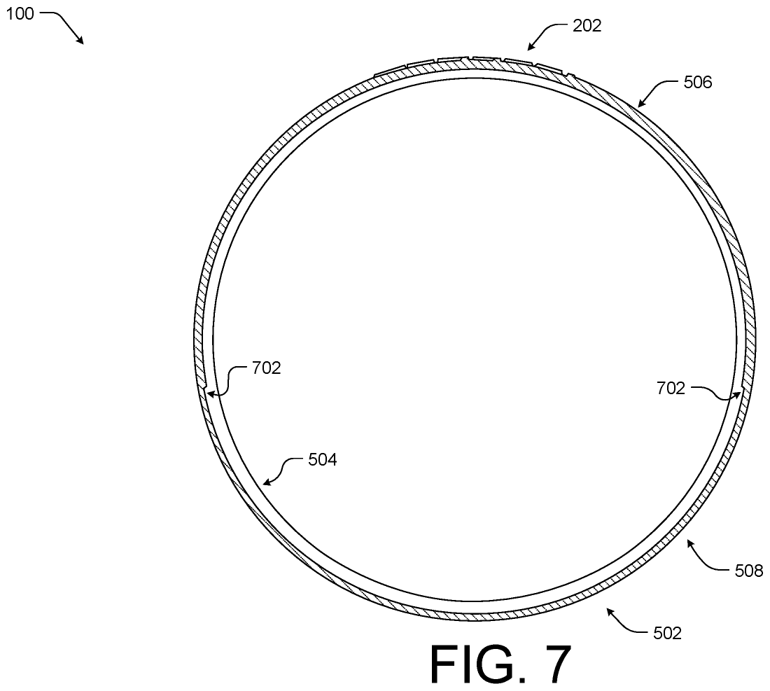

FIG. 7 is another top-down view of the example label of FIG. 1 in accordance with embodiments of the disclosure. As discussed above, the label 100 may have a first portion 506 that includes the molded or raised personal identification information 202. The label 100 also includes a second portion 508 that has the substantially unequal layers configured to allow for laser etching of the personal identification information along the surface of the label 100. As discussed above, the amount, length, or size of the first portion 506 and the second portion 508 may differ. For instance, in the current example, the thickness of the first layer 502 may transition, generally at positions 702, between a first thickness over the first portion 506 and a second thickness over the second portion 508. In this example, the thickness of the first layer 502 over the second portion 508 is less than the thickness of first layer 502 over the first portion 506. In this manner, the first layer 502 may be etched or other laser engraved to expose the second layer 504 in a customized manner. In these examples, the first portion may be a have a first color and the second portion may have a different second color. In some case, the first colors may be selected to contrast with the second color to improve overall visibility of the etched text or other content.

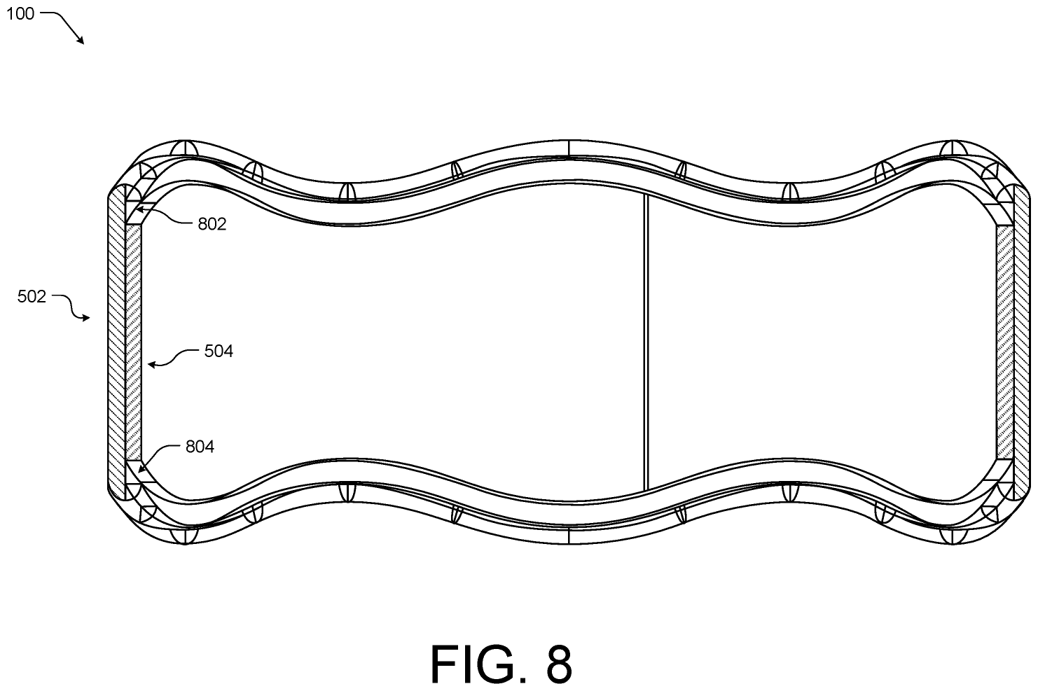

FIG. 8 is another cross-sectional view of the example label 100 of FIG. 1 in accordance with embodiments of the disclosure. In the current example, the cross section illustrates the first or outer layer 502 and the second or inner layer 504. As discussed herein, the first layer 502 may be a first material or color and the second layer 504 may be a second material or color. In this example, the second layer 504 may include a gap, generally indicated by 802 and 804, at the top and bottom of the label 100. The gap may be void of material or include material associated with the first layer 502.

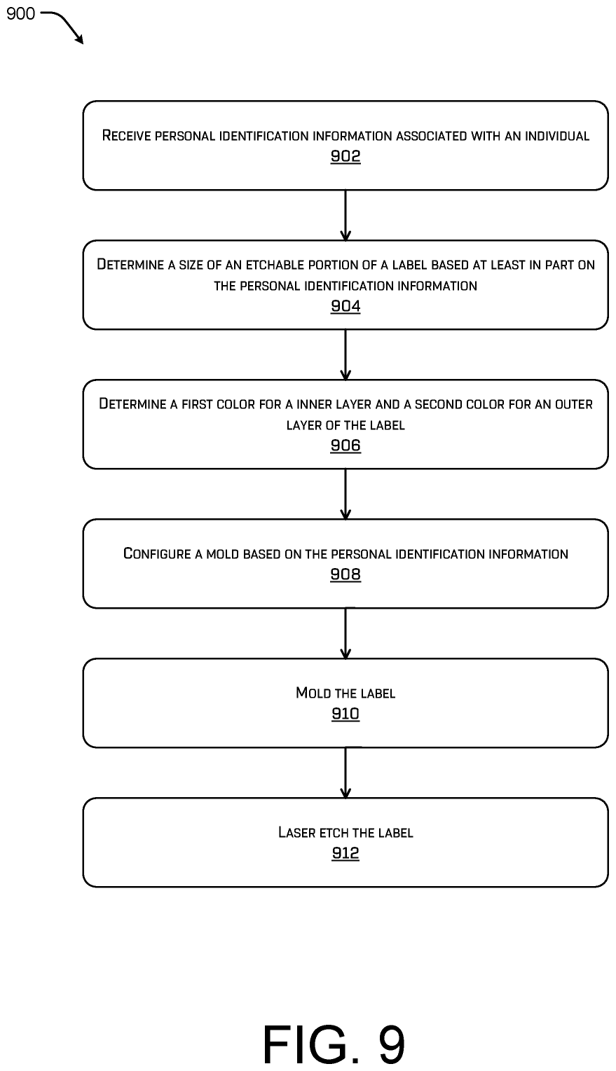

FIG. 9 is a flow diagram illustrating an example processes associated with the label 100 of FIG. 1 discussed above. The processes are illustrated as a collection of blocks in a logical flow diagram, which represent a sequence of operations, some or all of which can be implemented in hardware, software, or a combination thereof. The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 9 is a flow diagram illustrating an example process 900 associated with the label 100 of FIG. 1 in accordance with embodiments of the disclosure. As discussed above, the label 100 may be molded to include two or more layers of material, each layer having a different color. The thickness of the layers may vary along the length of the label 100 form substantially equal to the inner layers comprising greater than ninety-eight percent of the thickness of the label 100.

At 902, a system may receive personal identification information associated with an individual. For example, the personal identification information may include a name, address, phone number, and the like. The personal identification information may also include information associated with other individuals, such as parental information, emergency contact information, allergies or other medical data, and the like.

At 904, the system may determine a size of an etchable portion (e.g., the portion of the label 100 being etched with the personal identification information) of the label 100 based at least in part on the personal identification information. For example, system may determine the size or amount of the label 100 associated with the etchable portion based on a number of characters included in the personal identification information plus an additional threshold amount. For instance, the label 100 may size the etchable portion to have a small buffer such as one or two additional characters to both sides of the location at which the personal identification information will be etched.

At 906, the system may determine a first color for an inner layer and a second color for the outer layer of the label 100. For example, the first color and the second color may be selected by a user that is having the personal identification information etched and molded onto the label 100. In some cases, the first color and the second color will differ but in a specific example, the first color and the second color may include differences in shade, contrast and the like but be generally from the same color family. In some cases, by providing two different or contrasting colors between the first layer and the second layer, the personal identification information may more easily be seen and read when compared to conventional labels having only a single color.

At 908, the system may configure a mold based on the personal identification information. For example, the system may arrange a mold to include a brail version of the personal identification information along the surface of the label 100, as discussed above.

At 910, the system may mold the label and, at 912, the system may laser etch the etchable portion of the label 100 to include the personal identification information. For example, the system may cause the mold to be filled with the materials. In some cases, the system may cure the material using heat, light, and the like and then laser etch when the material is fully cured (e.g., after a predetermined period of time has elapsed).

A. A substantially cylinder shaped label comprising an inner layer of material having a first color; an outer layer of material having a second color; a first portion of the label at which the inner layer of material is greater than forty percent of the thickness of the label and the outer layer of material is greater than forty percent of the thickness of the label; and a second portion of the label at which the inner layer of material is greater ninety percent of the thickness of the label and the outer layer of material is less than ten percent of the thickness of the label.

B. The substantially cylinder shaped label of A, wherein the second portion of the label includes personal identification information associated with an individual, the personal identification information etched into the label such that the personal identification information is in the first color of the inner layer.

C. The substantially cylinder shaped label of A, wherein the first portion of the label includes personal identification information associated with an individual, the personal identification information raised from the surface of the label in brail such that the personal identification information is readable via touch.

D. The substantially cylinder shaped label as of A, wherein the first portion of the label is greater than or equal to ninety seven percent of the thickness of the label and the second portion is less than or equal to three percent of the thickness of the label.

E. The system as substantially cylinder shaped label of A, wherein the thickness of the label at the first portion is less than the thickness of the label at the second portion.

F. The system as substantially cylinder shaped label of A, further comprising a third layer, the third layer in contact with the inner layer on a surface opposite the outer layer.

G. The substantially cylinder shaped label of A, wherein the first portion of the label comprises greater than two-third of a length of the label.

H. The system as substantially cylinder shaped label of A, wherein the first portion of the label comprises greater than three-fourths of a length of the label.

I. A label for a drinking vessel comprising: a substantially ring-shaped body formed by at least a first layer and a second layer and having a total length and a total thickness, and wherein the length of the substantially ring-shaped body is divided into at least a first portion and a second portion, a first thickness of the first layer comprising approximately half of the total thickness and a second thickness of the second layer comprising approximately half of the total thickness at the first portion and the first thickness of the first layer comprising greater than or equal to ninety percent of the total thickness and the second thickness of the second layer comprising less than or equal to ten percent of the total thickness at the second portion.

J. The label of I, wherein the first layer of the body is formed from a material having a first color and the second layer of the body formed from a material having a second color, the second color different than the first color.

K. The label as recited of I, wherein the first portion of the label comprises greater than two-third of a length of the label.

L. The label of I, wherein the label includes personal identification information associated with an individual, the personal identification information associated etched into the label such that the personal identification information is in the first color of the inner layer.

M. The label of I, wherein the first portion of the label includes personal identification information associated with an individual, the personal identification information raised from the surface of the first portion of the label in brail such that the personal identification information is readable via touch.

N. The label of I, wherein the first thickness of the first portion is greater than or equal to ninety nine percent of the total thickness of the label.

O. The label of I, wherein a first length of the first portion is greater than or equal to two-third of the total length.

P. The label of I, wherein the total thickness is approximately 0.75 inches at the first portion and approximately 0.76 inches at the second portion.

Q. A ring configured to releasably couple to a drinking vessel comprising: a first layer of a first material; a second layer of a second material; a first portion comprising the first layer at a first thickness and the second layer at a second thickness; and a second portion comprising the first layer at a third thickness and the second layer at a fourth thickness, the third thickness greater than the first thickness and the fourth thickness less than the second thickness.

R. The ring of Q, wherein the ring includes a third portion between the first portion and the second portion to transition the first layer from the first thickness to third thickness and the second layer from the second thickness to the fourth thickness and a fourth portion between the first portion and the second portion to transition the first layer from the third thickness to first thickness and the second layer from the fourth thickness to the second thickness.

S. The ring of Q, wherein: the first layer has a first color and the second layer has a second color; and the second portion is etched to expose personal identification information in the first color along an exterior surface of the ring.

T. The ring of Q, further comprising a third layer, the third layer of the second material and positioned on an opposite side of the first layer from the second layer.

While the example clauses described above are described with respect to one particular implementation, it should be understood that, in the context of this document, the content of the example clauses can also be implemented via a method, device, apparatus, medium, and/or another implementation. Additionally, any of examples A-T may be implemented alone or in combination with any other one or more of the examples A-T.

What is claimed is:

1. A substantially cylinder shaped label comprising:
an inner layer of material having a first color;
an outer layer of material having a second color;
a first portion of the label at which the inner layer of material is greater than forty percent of the thickness of the label and the outer layer of material is greater than forty percent of the thickness of the label; and
a second portion of the label at which the inner layer of material is greater ninety percent of the thickness of the label and the outer layer of material is less than ten percent of the thickness of the label.

2. The substantially cylinder shaped label as recited in claim 1, wherein the second portion of the label includes personal identification information associated with an individual, the personal identification information etched into the label such that the personal identification information is in the first color of the inner layer.

3. The substantially cylinder shaped label as recited in claim 1, wherein the first portion of the label includes personal identification information associated with an individual, the personal identification information raised from the surface of the label in brail such that the personal identification information is readable via touch.

4. The substantially cylinder shaped label as recited in claim 1, wherein the first portion of the label is greater than or equal to ninety seven percent of the thickness of the label and the second portion is less than or equal to three percent of the thickness of the label.

5. The system as substantially cylinder shaped label in claim 1, wherein the thickness of the label at the first portion is less than the thickness of the label at the second portion.

6. The system as substantially cylinder shaped label in claim 1, further comprising a third layer, the third layer in contact with the inner layer on a surface opposite the outer layer.

7. The substantially cylinder shaped label as recited in claim 1, wherein the first portion of the label comprises greater than two-third of a length of the label.

8. The system as substantially cylinder shaped label in claim 1, wherein the first portion of the label comprises greater than three-fourths of a length of the label.

9. A label for a drinking vessel comprising:
a substantially ring-shaped body formed by at least a first layer and a second layer and having a total length and a total thickness, and wherein the length of the substantially ring-shaped body is divided into at least a first portion and a second portion, a first thickness of the first layer comprising approximately half of the total thickness and a second thickness of the second layer comprising approximately half of the total thickness at the first portion and the first thickness of the first layer comprising greater than or equal to ninety percent of the total thickness and the second thickness of the second layer comprising less than or equal to ten percent of the total thickness at the second portion.

10. The label as recited in claim 9, wherein the first layer of the body is formed from a material having a first color and the second layer of the body formed from a material having a second color, the second color different than the first color.

11. The label as recited in claim 9, wherein the first portion of the label comprises greater than two-third of a length of the label.

12. The label as recited in claim 9, wherein the label includes personal identification information associated with an individual, the personal identification information associated etched into the label such that the personal identification information is in the first color of the inner layer.

13. The label as recited in claim 9, wherein the first portion of the label includes personal identification information associated with an individual, the personal identification information raised from the surface of the first portion of the label in brail such that the personal identification information is readable via touch.

14. The label as recited in claim 9, wherein the first thickness of the first portion is greater than or equal to ninety nine percent of the total thickness of the label.

15. The label as recited in claim 9, wherein a first length of the first portion is greater than or equal to two-third of the total length.

16. The label as recited in claim 9, wherein the total thickness is approximately 0.75 inches at the first portion and approximately 0.76 inches at the second portion.

17. A ring configured to releasably couple to a drinking vessel comprising:
a first layer of a first material;
a second layer of a second material;
a first portion comprising the first layer at a first thickness and the second layer at a second thickness; and
a second portion comprising the first layer at a third thickness and the second layer at a fourth thickness, the third thickness greater than the first thickness and the fourth thickness less than the second thickness.

18. The ring as recited in claim 17, wherein the ring includes a third portion between the first portion and the second portion to transition the first layer from the first thickness to third thickness and the second layer from the second thickness to the fourth thickness and a fourth portion between the first portion and the second portion to transition the first layer from the third thickness to first thickness and the second layer from the fourth thickness to the second thickness.

19. The ring as recited in claim 17, wherein:
the first layer has a first color and the second layer has a second color; and
the second portion is etched to expose personal identification information in the first color along an exterior surface of the ring.

20. The ring as recited in claim 17, further comprising a third layer, the third layer of the second material and positioned on an opposite side of the first layer from the second layer.
